(19) United States
(12) Patent Application Publication
(10) Pub. No.: US 2026/0021777 A1
(43) Pub. Date: Jan. 22, 2026

(54) DECORATIVE PART AND METHOD FOR MANUFACTURING A DECORATIVE PART

(71) Applicant: JOYSONQUIN Automotive Systems GmbH, Rutesheim (DE)

(72) Inventor: Philip FRUCHT, Renningen (DE)

(21) Appl. No.: 19/270,670

(22) Filed: Jul. 16, 2025

(30) Foreign Application Priority Data
Jul. 19, 2024 (DE) 102024120505.9

(51) Int. Cl. B60R 13/02; B29C 45/14

(52) U.S. Cl. CPC B60R 13/02; B29C 45/14688

(57) ABSTRACT

A decorative part for the interior of a vehicle, with a visible side and a mounting side opposite the visible side, comprising a decorative element arranged on the visible side and a backing element arranged on the mounting side, which is spaced apart from the decorative element to form an intermediate space, wherein the backing element has at least one cavity which penetrates the decorative element at least in some areas, wherein the intermediate space is filled with an injection-molded plastic which also penetrates the at least one cavity of the backing element. The backing element is preferably made of natural fibers.

### FIELD OF THE INVENTION

The present invention relates to a decorative part for the interior of a vehicle, as well as to a method for manufacturing such an interior.

### BACKGROUND OF THE INVENTION

From DE 10 2012 014 082 A1, a molded decorative part is known in which a veneer layer is provided with a back-injection molded reinforcement layer and with an overmolded cover on the visible side.

In order to improve the ecological footprint of such molded decorative parts, there is a need to save material and/or to use biodegradable materials and/or materials of natural origin in the construction of such molded parts, for example in the form of natural fibers. Such molded decorative parts are described, for example, in EP 2 739 469 A1. Here, a carrier made of a material containing a natural substance is covered with a decorative layer of natural fibers, and the carrier and/or decorative layer is provided with a top layer.

However, such components have the disadvantage that the molded decorative parts can warp or deform after manufacture, in particular during cooling after manufacture, so that it has been difficult to date to save material or use materials of natural origin.

### SUMMARY OF THE INVENTION

Based on this, the problem underlying the present invention is to provide a decorative part and a method for manufacturing such a decorative part, which is improved with regard to possible mechanical warping.

To solve this problem, a decorative part for the interior of a vehicle is proposed, with a visible side and a mounting side opposite the visible side, comprising a decorative element arranged on the visible side and a backing element arranged on the mounting side, which is spaced apart from the decorative element to form an intermediate space, wherein the backing element has at least one cavity which penetrates the backing element at least in some areas, wherein the intermediate space is filled with an injection-molded plastic which also penetrates the at least one cavity of the backing element.

The term “hollow space” is to be understood broadly in this context. The hollow space can be understood as a microscopic (i.e., not visible to the naked eye) or macroscopic (i.e., visible to the naked eye) opening or through-hole, as an intermediate space between fibers, as pores, and the like. At least partial penetration means that at least one cavity is formed in at least one part of the backing element through which the plastic can penetrate from the front side of the backing element opposite the mounting side to the mounting side of the decorative part. A design configuration in which the backing element has several, preferably a large number of cavities is preferred.

The penetration of the backing element by the at least one cavity makes it possible for the injection-molded plastic to pass through this cavity and thereby stabilize the backing element in order to counteract warping. At the same time, the structure of the decorative part with a visible decorative element and a backing element on the mounting side allows for simple manufacture, since the plastic can be injection molded between the decorative element and the backing element in a single process step during manufacture. In particular, backing elements that are made entirely of a natural material can be used in a decorative part without significant warping problems. It is also possible to reduce the amount of material used for backing elements, which are also used for mounting the decorative part, for example, compared to conventional approaches. This makes the corresponding decorative parts lighter than decorative parts known from the prior art. Compared to decorative parts known from the prior art, the proportion of natural fibers can be increased.

At the same time, the backing element can be used in cooperation with the decorative element to create a visual impression, for example a three-dimensional depth effect, especially if the plastic is transparent or translucent. In particular, a moiré effect can be achieved through the interaction of the decorative element and the backing element. Preferably, an imprint can be made on the front side of the backing element facing the decorative element and thus the visible side, which is visible through openings, omissions or the like in the decorative element.

Preferably, the backing element has a surface facing the decorative element, and the proportion of openings of cavities in this surface to the entire surface is preferably not less than 5%. This achieves sufficient stabilization of the backing element, which counteracts mechanical warp. At the same time, large free spaces remain for the design or configuration of the backing element.

A thermoplastic, a thermoset or an elastomer is preferably used as the plastic, particularly preferably a thermoplastic which can be advantageously processed simply by injection molding. The plastic preferably comprises polyethylene (PE), polypropylene (PP), acrylonitrile-butadiene-styrene (ABS), polyamides (PA), polylactide (PLA), polymethyl methacrylate (PMMA), polycarbonate (PC), polyethylene terephthalate (PET), polystyrene (PS), polyetheretherketone (PEEK) and polyvinyl chloride (PVC). Polycarbonate, polyethylene and/or polypropylene are particularly preferred as plastics. The plastic also preferably comprises fibers, in particular glass fibers. A glass fiber content of up to 30% by weight is particularly preferred. The plastic is preferably transparent or translucent.

The decorative element is preferably made of a material comprising at least one of the following materials: metal, wood, plastic, carbon, a fiber composite material made of a thermoplastic plastic film and fibers, natural fibers, paper, organosheet or organic sheet metal, a hybrid material, and at least one pre-preg.

The backing element is preferably made of a material comprising at least one of the following materials: metal, wood, plastic, carbon, a fiber composite material consisting of a thermoplastic plastic film and fibers, and natural fibers.

Mats, in particular made of so-called organofoil (also organosheet), which have a proportion of fibers, in particular carbon or glass fibers, and which are provided with natural fibers, are preferably used as backing elements and/or decorative elements. The natural fibers are preferably applied as a nonwoven fabric. The visible side of the decorative element and/or the front side of the backing element are preferably metallized.

In this document, the term “natural fiber” refers to a fiber that comes from natural sources such as plants, animals, or minerals. Examples of natural fibers are plant fibers such as flax fibers.

The surface of the decorative element facing the visible side of the decorative part is preferably provided with a transparent and/or translucent coating which provides mechanical protection for the decorative element. The decorative element preferably has at least one cavity which penetrates the decorative element at least in some areas, wherein the at least one cavity of the decorative element is also interspersed or permeated with plastic, which simultaneously forms the coating of the decorative element on the visible side of the decorative part.

According to a preferred embodiment, the backing element has a plurality of uniformly distributed cavities. This means that microscopic and/or macroscopic cavities are distributed as uniformly as possible over the backing element in order to achieve the most uniform stabilization possible of the backing element and thus of the decorative part. Alternatively, it is also preferred that, in particular, the areas of the backing element and, if applicable, of the decorative element are provided with cavities which contribute or can contribute particularly to the mechanical warp of the decorative part. Alternatively, it is also preferred that the backing element has unevenly distributed cavities.

According to an advantageous embodiment, the decorative element has at least one cavity which penetrates the decorative element at least in some areas. This also allows the formation of a decorative element with reduced material usage and/or made of a natural material, which is stabilized by the plastic.

According to an advantageous embodiment, at least one of the components: a) the decorative element and b) the backing element comprises an area formed from fibers. The fibers are preferably metallic fibers, carbon fibers, and/or natural fibers. A fiber volume fraction of at most 60% is preferred. The term “fibers” also includes filaments in particular. The fiber volume fraction is calculated as the quotient of the fiber volume in the corresponding area and the volume of the corresponding area. If, for example, the backing element is made entirely of fibers, the fiber volume fraction is calculated as the quotient of the sum of the volume of these fibers and the volume of the backing element. Fiber volume fractions of no more than 60% ensure good penetration of the cavities formed by the fibers with molten plastic and thus a stable configuration of the decorative part.

Thermoplastic plastic is preferred. This facilitates the formation of the decorative part by intermediate injection or injection molding into the intermediate space, penetrating the at least one cavity of the backing element and, if necessary, also at least one cavity in the decorative element.

Preferably, the plastic comprises a glass fiber content. The use of such a glass fiber-reinforced plastic increases the strength of the decorative part.

Furthermore, a method for manufacturing a decorative part, in particular according to the present invention, in an injection mold with a cavity using a plastic is proposed, characterized by the following steps:
Inserting a decorative element with a visible side into the cavity so that the visible side points to a first longitudinal side of the cavity, preferably so that the visible side of the decorative element defines one side of the cavity
inserting a backing element with a front side into the cavity so that the backing element is spaced apart from the decorative element to form an intermediate space between the decorative element and the backing element, wherein the backing element has at least one cavity and is permeable to the molten plastic;
melting the plastic;
pressing the molten plastic into the intermediate space so that the plastic fills the intermediate space and penetrates the at least one cavity of the backing element, forming the decorative part.

This is a conventional injection molding process, with the difference that a plastic is not injection molded in a mold or injected in a mold onto a plastic part, but rather the plastic is injected into the intermediate space between the decorative element and the backing element and bonds with the decorative element and the backing element during cooling. Due to the permeability of the backing element for the molten plastic, the latter is pressed into the at least one cavity of the backing element and fills it. This stabilizes the backing element and reduces the possibility of mechanical warp of the decorative part, even when using a backing element made of less material than is known from the prior art and/or made of a material comprising natural fibers. This allows lighter decorative parts and/or decorative parts with a higher proportion of natural fibers to be manufactured.

Preferably, the decorative element has at least one cavity which penetrates the decorative element at least in some areas, wherein this cavity is filled or interspersed by the molten plastic when it is pressed in. This also allows a saving of material in the decorative element, which, due to the penetration of molten plastic during injection molding, leads to a stabilization of the decorative part in the area of the decorative element.

Preferably, the backing element and/or the decorative element has a plurality of uniformly distributed cavities. This achieves a more uniform distribution of the molten plastic in the backing element or in the decorative element and simplifies the injection molding process.

Preferably, at least one of the components: a) the decorative element and b) the backing element comprises an area formed from fibers, wherein the fibers form the cavities. Preferably, at least one of the components: a) the decorative element and b) the backing element is formed from a material comprising natural fibers, wherein the fibers form the cavities. This enables the formation of mechanically stable decorative parts with decorative elements and/or backing elements made of a material comprising fibers and, in particular, natural fibers. In this way, the proportion of natural fibers in the decorative part can be increased compared to known methods.

### BRIEF DESCRIPTION OF THE DRAWINGS

Further details and advantages of the present invention are apparent from the following description of an embodiment in conjunction with the drawing. This shows by:

FIG. 1: a schematic cross-sectional view of an embodiment of a decorative part; and

FIG. 2: a schematic example of an injection mold for manufacturing the decorative part.

### DESCRIPTION OF THE PREFERRED EMBODIMENTS

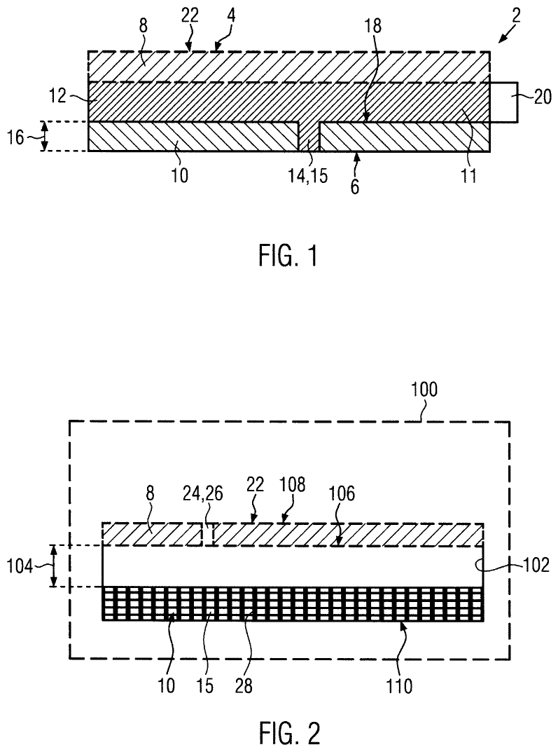

FIG. 1 shows a decorative part 2 for a vehicle, in particular a vehicle interior, with a visible side 4 and a mounting side 6 opposite the visible side 4. A decorative element 8 is formed on the visible side 4 of the decorative part 2, while a backing element 10 is formed on the mounting side 6. The decorative element 8 is used to emboss the visual impression of the decorative part 2 when viewed from the visible side 4. The backing element 10 serves to stabilize and mount the decorative part 2.

The area between the decorative element 8 and the backing element 10 is an intermediate space 11 filled with a plastic 12. The plastic 12 is preferably transparent and/or translucent, in particular transparent in some areas and translucent in other areas. The plastic 12 is introduced by an injection molding process. This is described in more detail below with reference to FIG. 2. The backing element 10 has at least one opening 14 so that the plastic 12 penetrates the opening 14 and thus the backing element 10. The plastic 12 preferably comprises fibers, in particular glass fibers. The plastic 12 is preferably a thermoplastic, a thermoset or an elastomer, particularly preferably a thermoplastic. The plastic 12 preferably comprises polyethylene (PE), polypropylene (PP), acrylonitrile butadiene styrene (ABS), polyamides (PA), polylactide (PLA), polymethyl methacrylate (PMMA), polycarbonate (PC), polyethylene terephthalate (PET), polystyrene (PS), polyether ether ketone (PEEK), and polyvinyl chloride (PVC). The use of polycarbonate, polyethylene and/or polypropylene as plastic 12 is particularly preferred.

The embodiment of decorative part 2 shown in FIG. 1 shows a cavity 15 formed as an opening 14, which penetrates the entire thickness 16 of backing element 10. This is not absolutely necessary, since according to the present invention, the backing element 10 as such is permeable to the molten, viscous plastic 12 before it is injected. This can be achieved by one or more continuous openings 14, openings that are not completely continuous but are connected to other openings, or by pores. According to the present invention, it is also possible to form the backing element 10 from fibers through the intermediate spaces between which the molten plastic 12 can pass. The fibers can be formed from at least one plastic, at least one metal, glass, carbon, and/or at least one natural fiber. In this context, the backing element 10 is preferably formed from a nonwoven fabric. The backing element 10 can be metallized, at least in some areas, on a front side 18 opposite the rear or mounting side 6.

FIG. 1 also shows an optional light source 20, via which light can be introduced into the plastic 12, in the embodiment shown, laterally between the decorative element 8 and the backing element 10. Instead of a light source 20, a corresponding light guide can also be formed, which can introduce light from a light source into the plastic 12. Alternatively or additionally, light can also be introduced into the plastic 12 from the mounting side 6 in at least one opening 14.

The decorative element 8 has a decorative side 22 that is visible from the visible side 4 of the decorative part 2. Depending on the configuration of the decorative element 8, which is preferably transparent or translucent in some areas, the front side 18 of the backing element 10 may also be visible from the visible side 4 of the decorative part 2. In this case, at least part of the front side 18 of the backing element 10 is preferably printed or coated.

A method for manufacturing a decorative part 2 according to the present invention is explained below with reference to FIG. 2. A cavity 102 is formed in an injection mold 100, the internal dimensions of which essentially correspond to the dimensions of the finished decorative part 2. The decorative element 8 is inserted into the cavity 102 and fixed in place. At a later stage or simultaneously, the backing element 10 is inserted into the cavity 102 and held in place at a distance 104 from the decorative element 8. In this example, the backing element 10 is made of fibers 28 that have been bonded to form a nonwoven fabric. Cavities 15 are formed in the nonwoven fabric between the fibers 28, which are only partially provided with reference signs for the sake of clarity. In this example, the fibers 28 comprise natural fibers such as flax fibers. In this example, the decorative element 8 also has a cavity 24, which is configured as a continuous opening 26.

The decorative element 8 is inserted into the cavity 102 in such a way that the decorative side 22 is oriented toward a first longitudinal side 108 of the cavity 102, on which the visible side 4 is formed after completion of the decorative part 2. The backing element 10 is positioned in the cavity 102 such that the front side 18 of the backing element 10 is oriented toward the decorative element 8 and the intermediate space 106 between the decorative element 8 and the backing element 10 remains. The backing element 10 lies against a second longitudinal side 110 of the cavity 102, which is formed opposite the first longitudinal side 108 of the cavity 102, or has a small gap through which the molten plastic 12 can press through during injection molding to form a layer not shown. The second longitudinal side 110 forms the mounting side 6 of the decorative part 2. FIG. 2 shows the injection mold 100 with the decorative element 8 and backing element 10 inserted before the molten plastic 12 is pressed in, i.e. before the actual injection molding process is carried out.

After the decorative element 8 and the backing element 10 have been inserted, the plastic 12 is pressed in molten form under pressure into an intermediate space 106 between the decorative element 8 and the backing element 10. The backing element 10 is permeable to the molten plastic 12 through the cavities 15, so that the opening 14 in the backing element 10 according to FIG. 1 and also the cavities 15 in the nonwoven fabric of the backing element 10 according to FIG. 2 are interspersed with the plastic 12. The molten plastic 12 also passes through the exemplarily shown cavity 24 of the decorative element 8. The cavities 15, 24 in the backing element 10 and decorative element 8 stabilize the backing element 10 and the decorative element 8.

After the plastic 12 has hardened, the plastic 12 stabilizes the backing element 10 so that deformations of the backing element 10, which could lead to damage to the decorative part 2, are avoided. Even if the backing element 10 is made of a fiber material, additional openings 14 can be provided in the fiber material, for example to define mounting points or a light entry for illuminating the decorative part 2. After or during the injection molding described here, the visible side 22 of the decorative element 8 can be provided with a transparent and/or translucent coating, which is not shown here.

What is claimed is:

1. A decorative part for an interior of a vehicle, with a visible side and a mounting side opposite the visible side, comprising:
a decorative element arranged on the visible side and a backing element arranged on the mounting side, the backing element is spaced apart from the decorative element to form an intermediate space, wherein the backing element, has at least one cavity which penetrates the backing element at least in some areas, wherein the intermediate space is filled with an injection-molded plastic which also penetrates the at least one backing element cavity of the backing element.

2. The decorative element according to claim 1, wherein:
the backing element has a plurality of evenly distributed backing element cavities.

3. The decorative part according to claim 1, wherein:
the decorative element has the at least one decorative element cavity which penetrates the decorative element at least in some areas.

4. The decorative part according to claim 1, wherein:
at least one of the decorative element and the backing element comprises an area formed from fibers.

5. The decorative part according to claim 1, wherein:
at least one of the decorative element and the backing element is formed from a material comprising natural fibers.

6. The decorative part according to claim 1, wherein:
the backing element is made of natural fibers.

7. A method for manufacturing a decorative part in an injection mold with a mold cavity using a plastic material, the method comprising the following steps:
inserting a decorative element with a visible side into the mold cavity so that the visible side points to a first longitudinal side of the mold cavity,
inserting a backing element with a front side into the mold cavity so that the backing element is spaced apart from the decorative element to form an intermediate space between the decorative element and the backing element, wherein the backing element has at least one backing element cavity and is permeable to a molten plastic;
melting the plastic material; and
pressing the melted plastic material into the intermediate space so that the plastic material fills the intermediate space and passes through the at least one backing element cavity of the backing element to form the decorative part.

8. The method according to claim 7, wherein:
the backing element has a plurality of evenly distributed backing element cavities.

9. The method according to claim 7, wherein:
the decorative element has at least one decorative element cavity which penetrates the decorative element at least in some areas and the at least one decorative element cavity is penetrated by the melted plastic when it is pressed in.

10. The method according to claim 7, wherein:
at least one of the decorative element and the backing element comprises an area formed from fibers, wherein the fibers form cavities.

11. The method according to claim 7, wherein:
at least one of the decorative element and the backing element is formed from a material comprising natural fibers, wherein the natural fibers form cavities.
